(19) United States
(12) Patent Application Publication
(10) Pub. No.: US 2009/0200530 A1
(43) Pub. Date: Aug. 13, 2009

(54) High Load Block Construction and Connection

(76) Inventor: Donald Butler Curchod, New South Wales (AU)

Correspondence Address: JOHN ALEXANDER GALBREATH, 2516 CHESTNUT WOODS CT, REISTERSTOWN, MD, 21136, US

(21) Appl. No.: 11/721,537

(22) PCT Filed: Dec. 13, 2005
(86) PCT No.: PCT/AU05/01872

§ 371 Date: Jun. 13, 2007

(30) Foreign Application Priority Data
Dec. 13, 2004 (AU) 2004907083
Feb. 16, 2005 (AU) 20059000708

(51) Int. Cl. B66D 3/04

(52) U.S. Cl. 254/390

(57) ABSTRACT

A high load lightweight block assembly (1) with a reduced mass hollow central shaft (2) through which a continuous or discontinuous rope loop (10) can be passed, which rope loop (10) carries the tensile operating loads within the block (1) thereby minimising the weight of the assembly.

### FIELD OF INVENTION

This invention relates to a high load lightweight construction and connection system for blocks particularly for use in sail boats by the use of lightweight material design and method.

### PRIOR ART

Historically, high load blocks and their connection have been constructed with the stresses within the block and connection being taken by metal including stainless steel, resulting in relatively high weight. Recently more advanced designs have replaced some metal with high strength braid, such as those sold under the trade marks Spectra, Dyneema etc. with a resultant reduction in weight. Since in a yacht, reduction in weight can be directly translated into improved performance there exists a need to further reduce weight in high load yacht fittings such as blocks and their connection.

### SUMMARY OF THE INVENTION

The present invention relates to a design utilizing a loop of high strength braid or similar, as those sold under the trade marks Spectra, Dyneema etc and a subsequently reduced metal mass in the hollow shaft of the block to further reduce the weight and hence increase the performance of high load blocks and their construction over the current state of the art.

An object of an embodiment of the invention is to provide a high load lightweight block with a reduced mass hollow central shaft through which a continuous rope loop can be passed, which rope loop carries the tensile operating loads within the block thereby minimising the weight of the assembly. This new technique or invention provides in some embodiments, the minimal amount of metal in the block and the maximum amount of high strength lightweight rope while maintaining alignment within the block, compared to current designs.

Another object of an embodiment of the invention is to provide a high load lightweight block with a reduced mass hollow central shaft through which a continuous rope loop can be passed, which rope loop carries the tensile operating loads within the block thereby minimising the weight of the assembly. This new technique or invention provides the minimal amount of metal in the block and the maximum amount of high strength lightweight rope while maintaining alignment within the block, compared to current designs, which employs a lightweight swivel attachment assembly.

Another object of an embodiment of the invention is to provide a high load lightweight block utilizing a rope loop connection but with a minimal amount of metal in the construction of the block compared to state of the art designs and which has the invention of a loop that can be easily connected and disconnected utilising a new type of joint construction of two eyes and a roughly circular head.

Another object of an embodiment of the invention is to provide a high load lightweight block with a rope loop connection for both the block and a Becket.

Another object of an embodiment of the invention is to provide a high load lightweight block with a rope loop connection for both the block and a Becket and or a spriddle.

Another object of an embodiment of the invention is to provide a high load lightweight block with a rope loop connection where the rope loops are set under load correctly in line.

Yet another object of an embodiment of the invention is to provide a high load lightweight block with a continuous rope loop where the connection to the block uses a secondary loop with a lightweight connection system that can be readily connected and disconnected and where this secondary loop can be used to connect a variety of objects in a lightweight compact manner.

Yet another object of embodiments of the invention is to provide a device to maintain the connection to the loop, central to the block centreline.

Yet another object of embodiments of the invention is to provide a quickly fitted and removed locking wrap to maintain the connection to the block loop, central to the block centreline.

Yet another object of embodiments of the invention is to provide a secondary continuous connection loop to a block which block employing a primary continuous load loop passing through the block centre, which provides a parallel connection with block shaft centre.

Yet another object of embodiments of the invention is to provide a secondary continuous connection loop to a block which block employs a primary continuous load loop passes through the block centre, which can by the addition of new type of bracket allow for angular misalignment of said block between the two connection loops.

In one broad form the invention provides a block including:
at least one sheave mounted for rotation about a hollow axle;
at least one length of material extending through the hollow axle and around the sheave,
whereby a tensile load may be transferred from the at least one length to the sheave via the hollow axle.

At least one length may have two ends. The at least one length may form at least one discontinuous loop. The at least one length may form at least one continuous loop that extends through the axle.

At least two ends may each engage an opposite end of the axle.

At least one of the ends may include a head assembly. At least one head assembly may include an eye and a pin located within the eye. The eye is preferably sized so that when the pin is not located in the eye, the eye may pass through the axle.

At least one head assembly may include a head, said head having a bore through which the first eye may pass through when the pin is not located in the eye. The bore may include a countersunk portion at one end thereof for receiving the first eye with the end of the loop extending through the bore.

The head may comprises a cone with a planar base, said bore extending generally along the axis of the cone from the planar base to the apex of the cone. The countersunk portion may be at the end of the bore remote from the planar base.

The head may be toroidal.

At least two of the ends may include a head assembly.

Another of the ends may include a second eye, said second eye and a head assembly adapted to engage each other. The second eye and the head assembly may be located at opposite ends of the same length of material. The second eye and the head assembly may be located on different lengths of material.

The block may include at least one side plate extending on either side of the sheave and spacing the at least one length from the sheave. The at least one length may be secured to at least one side plate. At least one strap may also extends around the side plates and the at least one length.

The block may also include a spacer assembly extending between said side plates. The at least one strap may be secured to the spacer assembly.

The block may also include a swivel assembly supported by said at least one loop. The swivel assembly may also include:
a support member supported by said at least one loop, and
a keeper, rotatably mounted on the support member, said keeper for attachment to a tensile load.

The keeper preferably rotates about an axis substantially perpendicular to the axis of rotation of the sheave.

The support member may be supported by at least two sets of sections of loop material, said sets being spaced apart and generally parallel to each other.

Each of the at least two sets may extend through a respective bore in the support member, said bores being spaced apart and generally parallel.

The at least two sets may extend under the support member.

The at least two sets may extend generally parallel to the axle. The at least two sets may extend generally perpendicular to the axle.

The keeper may have a bore adapted to receive a loop.

As used throughout the description and the claims a continuous loop includes a length material in which the ends have been spliced together or permanently affixed together. A discontinuous loop includes a length material in which the ends can be selectively and repeatedly connected and disconnected

Unless the context clearly requires otherwise, throughout the description and the claims the words ‘comprise’, ‘comprising’, and the like are to be construed in an inclusive sense as opposed to an exclusive or exhaustive sense; that is to say, in the sense of “including, but not limited to”.

### BRIEF DESCRIPTION OF DRAWINGS

FIG. 1 shows a cross section of a high load lightweight block with a hollow central shaft and an elongate rope loop connection which can be readily connected and disconnected.

FIG. 2 shows a cross section of a high load lightweight elongate rope loop with a connection which can be readily connected and disconnected.

FIG. 3 shows a cross section of the high load lightweight block as in FIG. 1, with an elongate continuous rope loop connection together with an isometric view of a secondary rope loop similar to the loop of FIGS. 1 and 2 with a high load lightweight connection which can be connected and disconnected readily.

FIG. 3a shows and end elevation of head of a secondary connectable loop of FIG. 3.

FIG. 3b shows a block similar to that of FIG. 3, but with a non continuous loop.

FIG. 4 shows a cross section of a high load lightweight block as in FIG. 1 with a high load lightweight sheave construction.

FIG. 5 shows an isometric view of the high load lightweight block of FIG. 1, with an elongate continuous double rope loop connection together with a separate loop or loops for a Becket.

FIG. 5b shows a partial isometric view of the high load lightweight block of FIG. 1, with an elongate continuous double rope loop connection together with a separate loop for a Becket, which loop does not pass through the centre of the block.

FIG. 5c shows a partial isometric view of the central section of the high load lightweight block of FIG. 1, with an elongate continuous double rope loop connection together with a separate loop for a Becket, which loop passes through the centre.

FIG. 5d shows an isometric view of portion of the high load lightweight block of FIG. 1, with an elongate continuous double rope loop connection together with a separate loop for a Becket.

FIG. 5a shows an isometric view of the central portion of the high load lightweight block of FIG. 5, with an elongate continuous double rope loop connection together with an alternative separate loop for a Becket.

FIG. 6 shows a part section elevation of an alternative high load lightweight sheave construction.

FIG. 7 shows an isometric view of the high load lightweight block as in FIG. 1, with an elongate continuous rope loop which continuous loop is connected to a swivel assembly having a secondary connection loop.

FIG. 7a shows a cross section of the high load lightweight block swivel assembly and secondary loop of FIG. 7 in which second loop is more easily dis-connectable.

FIG. 8 shows an isometric view of an alternative to the block 220 of FIG. 7.

FIG. 9 is an alternative part section of FIG. 1 with a modified wrap.

FIG. 10 is an alternative part section elevation of FIG. 3 with an alternative secondary connection loop.

FIG. 10a is an alternative part section elevation of FIG. 3 with an alternative secondary connection loop swivel

FIG. 10b is a part cross section of block of 10a

### DETAILED DESCRIPTION OF THE PREFERRED EMBODIMENTS OF THE INVENTION

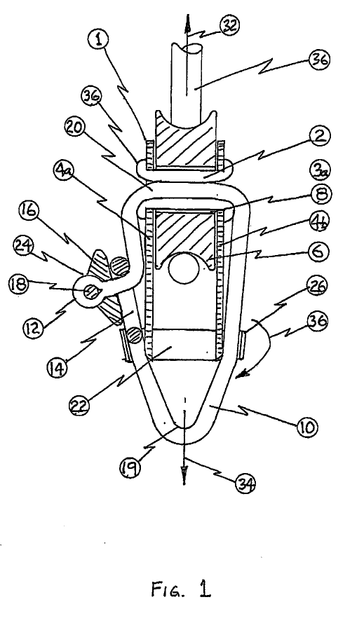

FIG. 1 shows a typical block 1 according to the present invention where hollow shaft 2 with bosses 3a and 3b has side plates 4a and 4b and sheave 6 with bearing 8.

Not shown is thread of one of side bosses 3a or 3b of shaft 2, required in order to assemble block.

Loop 10, with eyes 12 and 14 (shown sectioned) passes through hollow shaft 2 at 20 and around block 1 past compression member 22 and is connected to itself at head 24 to form an easily connected and disconnected connection loop 10.

Loop 10 is retained in position on block 1, by strap 26 which wraps around block 1 shown by arrow 36.

Load is applied via rope 36 around sheave 6, at 32 on one end and at 34 on the other end such that tensile forces when load is applied to block 1 are taken by loop 10 via centre of sheave 6.

If desired, two or more lengths of material, each having a head and an eye may be daisy chained together to form a single loop.

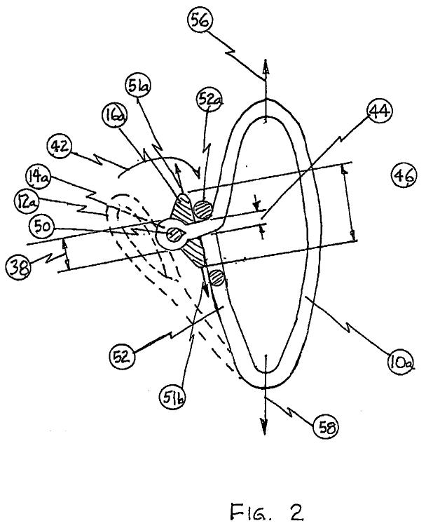

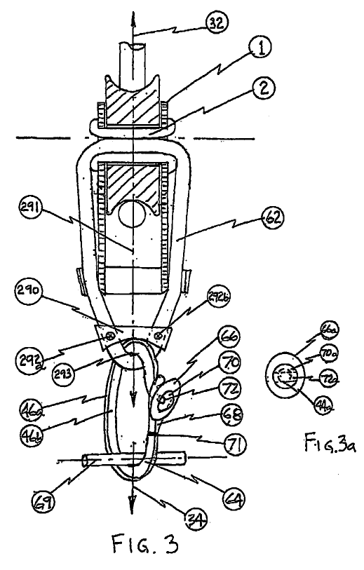

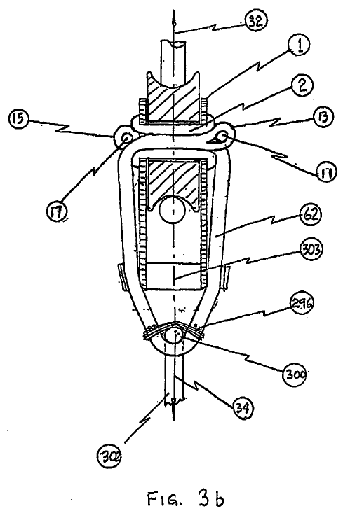

FIG. 2 shows the loop of FIG. 1 as a separate identity with the ability of being used to connect not only block 1 of FIG. 3, but a wide variety of other objects. With regard to FIG. 2, shows a loop 10a similar to loop 10 of FIG. 1 and loop 10b similar to of FIG. 3.

Rope loop 10a with formed eyes 12a and 14a (typically formed by splicing) has a toroidal head 16a. Toroidal head 16a has centre hole 44, outer diameter 46 and counter-sunk bore 38. Loop 10a is a snug fit in centre hole 44. Eye 14a has a cross pin 50 of such a diameter that eye 14a and pin 50 form a head which fits in counter-sunk bore 38 and is substantially larger than centre hole 44.

Eye 12a, shown by dotted lines of loop 10a, fits over toroid 16a and outer diameter 46 shown by arrow 42 into position 52a and 52b so that loop 10a forms a continuous closed loop which is readily connected and disconnected to form a tensile connection between opposing loads applied at 56 and 58 respectively.

Such a connection, when loaded, stresses toroid 16a radially, shown at 51a and 51b, and produces a significantly smaller and lighter connection head 16a than current “dog bone” type connections.

Hole 44 has a radius at each end. When loaded, head 16a is jammed into and restrained by hole 44 and this jamming action places pin 50 in compression.

This jamming action in hole 44 allows eye 14a, if spliced to have a much shorter tail to hold high loads at 56 and 58 than would otherwise be possible.

Spliced eye 12a is only slightly larger than outer diameter 46 of toroidal head 16a and hence, when passed over head 16a to position 52a and 52b, and load is applied at 56 and 58, eye 12a will remain locked in position 52a to form a highly reliable easily connectable high load connection.

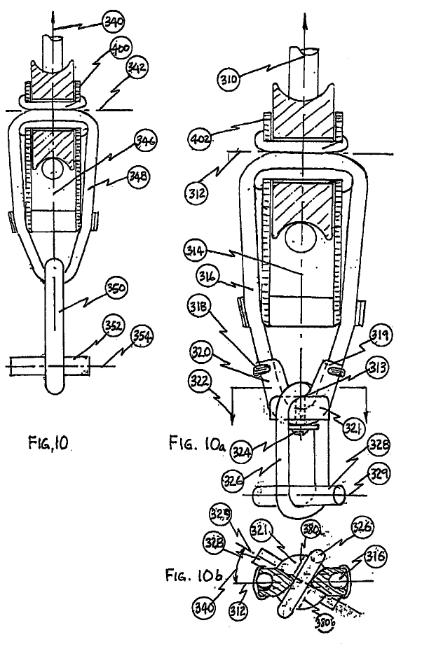

FIG. 3 shows block 1 which is similar to that of FIG. 1 but has a loop 62 which is continuous. Connection of block is made by secondary loop 64, similar in construction to loop 10 of FIG. 1 and 10a of FIG. 2. This loop 64 can be readily attached and detached via toroidal head 66 and eye 68, with eye 70. Eye 68 is formed by a tie shown at 71.

To aid in ensuring that loads 32 and 34 via loops 46 and 62 always pass through or close to the centre line of the block 291, a locating bracket 290 is preferably provided to retain block connection point 293 centrally. The bracket 290 is preferably secured with locating screws 292a and 292b, which screw into the loop 62. Other fastening methods may be used. Other methods of retaining the loop 46 generally centrally may also be used. The bracket 290 is not essential and may be omitted.

Pin 72 restrains head 66, forming a connection similar to that of FIG. 2 except that FIG. 3 shows a double loop 46a and 46b. Using a double loop with single head 66 allows for a smaller joint than with a single loop. This also allows block to be connected to shaft 69 parallel to shaft of 2 of block 1, as shown, or to shaft 69 such that shaft 2 of block 1, is perpendicular to shaft 69. The load direction is shown by arrows 32 and 34.

FIG. 3a shows a view of head 66 of FIG. 3.

Outer diameter 66a, which is roughly circular, has counter bore and shows head 70a, centre hole 44a and pin 72 of FIG. 3, at 72a.

FIG. 3b shows block assembly of FIG. 3, in which loop 62 is not continuous but has spliced eye ends 15 and 16 respectively on each side of block 1. Pins 11 and 17 secure spliced ends 13 and 15 so that loop 62 will hold when loaded at 32 and 34.

In order that loads 32 and 34, via loops 62 and 302, preferably pass through or close to the centre line of the block 291 a locating whipping 296 is provided to retain block connection point 300 centrally. It will be appreciated that the bracket of FIG. 3 may be used instead. Similarly, the whipping of FIG. 3b may be used with the embodiment of FIG. 3. The whipping 296 is not essential and may be omitted.

If desired, the single loop may be formed of two or more lengths of material that are joined together using a head and eye arrangement as in FIGS. 1 and 2 with the free ends of the chain of lengths engaging in opposite ends of the hollow axle.

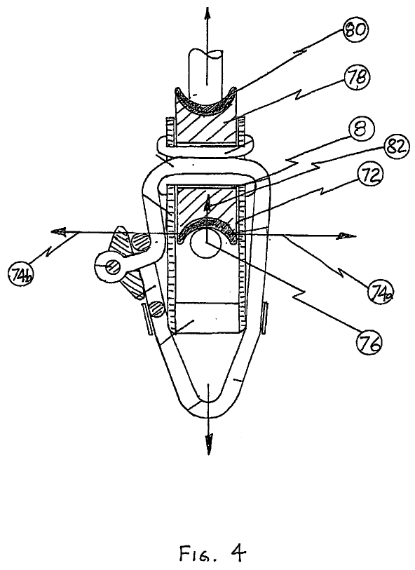

Regarding FIG. 4, the block arrangement, which is similar to that of FIG. 1, has sheave 72 with bearing 8. For high loads, such a sheave is currently typically made of metal so as to contain spreading forces shown at 74a and 74b generated by loaded rope section 76.

Sheave 72 of FIG. 4 is constructed with outer layer 80 made of lightweight plastic reinforced by fibers such as carbon fiber running predominantly in direction 74a and 74b (note, layer 80 may be either cored or uncored as shown) so as to restrain spreading forces in the direction of arrows 74a and 74b.

The centre 78 of sheave 72, being under mostly compression forces 82, can be made with numerous filled or unfilled lightweight plastic materials.

In this way a lightweight plastic sheave can be constructed to withstand similar loads to that of a heavier metal sheave.

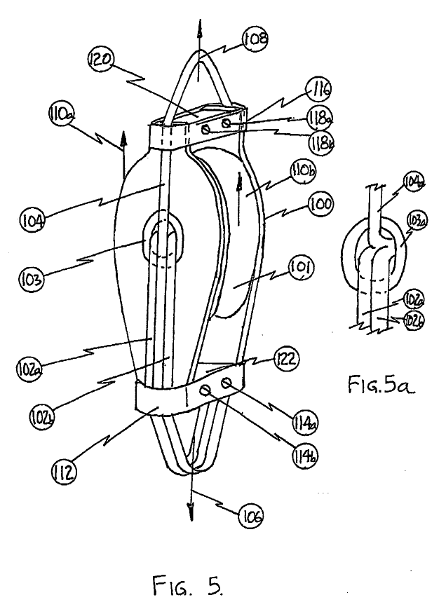

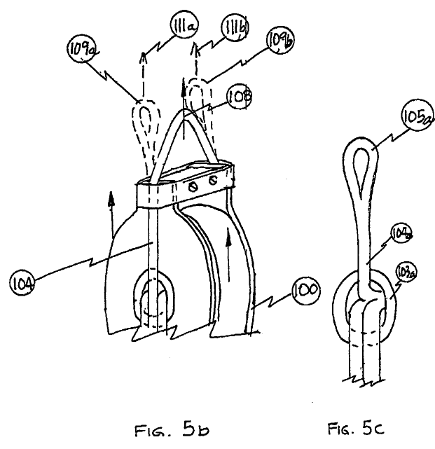

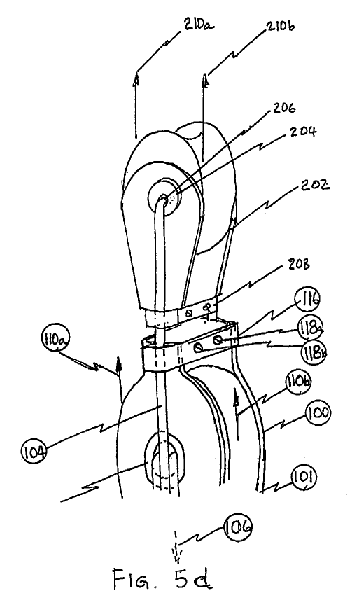

FIG. 5 shows the outline of a block 100 according to the present invention and is similar to the blocks of FIG. 3 but with dual loops. The primary loop is doubled at 102a and 102b and connects the central shaft 103 to connection point 106. The primary loops 102a and 102b are held in place by strap 112 and screws 114a and 114b and piece 122 opposes the compression forces when block 100 is loaded.

FIG. 5 also shows a second single loop 104 (which could also be a double loop) for a Becket connection. Becket loop 104 connects point 108 to opposite end 106. Secondary Becket loop 104 is retained by strap 116 and screws 118a and 118b and block 120 resists compression of loop 104 when loaded.

This connection of the Becket loop 104 increases the load of the block by 50%, compared to traditional Beckets and compared to FIG. 5a, an alternative construction, which shows the central shaft 103 portion of FIG. 5 but has Becket loop 104a passing through the central shaft 103a together with primary loop or loops 102a and 102b and this FIG. 5a configuration does not increase the load bearing capacity of the block assembly.

In FIG. 5, loads are shown for sheave 101 at 110a and 110b, and at Becket 108 opposed by forces at connection point 106.

FIG. 5b shows an alternative Becket connection of block 100 of FIG. 5 where Becket loop 108 is not continuous, but is formed from two loops 109a and 109b taking Becket loads 111a and 111b.

FIG. 5c shows central portion 103a of block 100 of FIG. 5, having Becket loop 104 which is not continuous but has two end loops for the Becket connection, one of which is shown at 105a.

FIG. 5d shows a portion of block 100 of FIG. 5 where loop 104 passes through second spriddle block 202 via centre of hollow shaft 204 at 206 and restrained by strap 208 so that assembly forms a spriddle block 202 having rope loads 210a and 210b added to rope loads 110a and 110b, all terminating at point 105 (not shown) and restrained by opposite load shown dotted at 106.

It is important in high load blocks that the load as shown in FIG. 1, by arrow 32 of rope 36, be perfectly in line with respect to block 1 and connection point 34, to avoid cocking and damage. Since rope loop 10 is pliable when first fitted it can easily become misaligned when first loaded.

This problem can be avoided by the method of loading block 1 of FIG. 1 at load point 34 to at least 10% of its rated value making sure point 34 when so loaded, is exactly aligned with block sheave 6 having direction 32.

In this way, correct point 34 becomes stiff and set in loop 10, so that that when connected in the field, a mating part will automatically align itself in the pre formed radius 19 of 34 so that block does not cock under load.

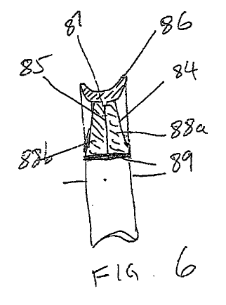

FIG. 6 shows sheave 84 similar to that of 72 of FIG. 4, with bearing 8 but where outer portion 86 is made with reinforced plastic or in lightweight metal

It should be noted with regard to FIG. 6, that tab 87 formed in outer portion 86 maintains alignment of outer portion 86 in body of sheave 88a and 88b while central portion 88a and 88b is made of plastic material glued together at 85.

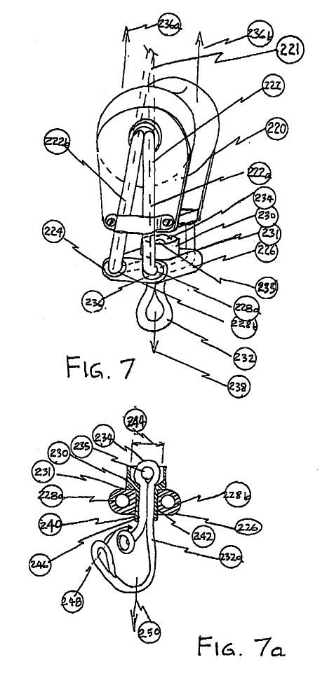

FIG. 7 shows a block 220 similar to blocks 1 of FIG. 1 and 100 of FIG. 5 but has loop 222 passing through a swivel assembly 224.

Swivel assembly 224 comprises a one piece block 226 (or alternatively multiple pieces).

Block 226 has two holes 228a and 228b with radius entry points 236 through which double loop 222a and 222b respectively pass. Block 226 has a central hole through which tube 230, having shoulder portion 231, passes.

Loop 232 fits through centre of tube 230 and is restrained by pin 235 so as to form connection loop 232 such that when load at block shown by 236a and 236b and opposing load 238 is applied, block 220 and loads 236a and 236b is able to rotate about tube 230 and opposing load at 234.

Shown at 221 in dotted outline is the possibility of the addition of a spriddle, or Becket (or both) to block 220.

FIG. 7a shows a cross section of swivel assembly 224 of FIG. 7, but where loop 232a has a quick connection similar to that of FIGS. 1 and 2. Block 228 has holes 228a and 228b and central hole 242 through which reduced diameter portion 240 passes. The shoulder 231 of tube 230 bears on the upper surface of the block 226 so that tube 230 and loops 232 or 232a are able to rotate with respect to block 226 and hence block 220 of FIG. 7.

The inside diameter 246 of through tube 230 is such that loop 232a is a tight fit, Loop 232a has head 234 forming a loop with pin 235 such. that head 234 sits in socket 244, which is substantially larger than the diameter of hole 246 of portion 240.

When loop 232, closed at 248, is loaded at 250, loop 232a is restrained by block 226 by the head 234 being substantially larger than the hole 246. Load is transferred to shoulder 231 and hence to loops 222a and 222b and finally to sheave wraps 232a and 232b of FIG. 7 to form a lightweight high load block which can be aligned in any direction.

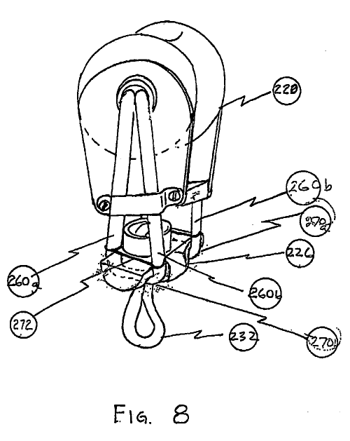

FIG. 8 shows an alternative to the block 220 of FIG. 7, with swivel assembly 280 having loop legs 260a and 260b at 90 degrees to that of legs 222a and 222b of FIG. 7. The swivel body 282 incorporates a continuous loop 232 and tube 230 as in FIGS. 7 and 7a. However, the swivel body 282 does not include bores through which the loops 260a & 260b pass. Instead loops 260a & 260b pass underneath the swivel body 282 at 270a and 270b. Thus there is no material at 270a and 270b under loop 260a and 260b. Ties 272a & 272b keep loops 260a and 260b in contact with swivel body 226.

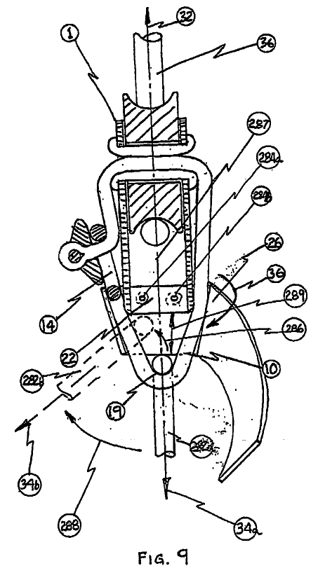

FIG. 9 shows a variation of the FIG. 1 embodiment designed to maintain loadings on or near the centreline of the block.

It is possible when the soft loop block 1 of FIG. 9 is unloaded, for connection 282a to move from central connection point 19 to an off centre point shown by arrow 286, at dotted position 282b. Thus, when block is re loaded at 32, load line 282a, which has moved from central point 19 to off centre point 282b, causes undue side load to be applied to block 1.

In order to avoid this potentially damaging situation a wrap 26 is provided which bridges the gap 289 so that connection 282a is unable to move from central position 19.

The wrap 26 is preferably connected to block spacer 22 via screws 284a and 284b and is provided with hook and loop fastener material at its ends, such as that sold under the brand name of Velcro, so that the wrap 26 is easily and quickly done up and undone. It will be appreciated that the wrap 26 may be used with the embodiments of FIGS. 3 and 3a. Similarly, the bracket 290 of FIG. 3 and the wrapping 296 of FIG. 3b may be used with the FIG. 9 embodiment.

FIG. 10 shows a block 400, which is identical to block 1 of FIG. 3, but which has a continuous secondary loop 350. The block 400 can be attached to a boat via shaft 352 so that, when loaded, axis of shaft 342 of block 400 is parallel to the centreline 354 of shaft 352.

FIGS. 10a and 10b show a block 402 having a continuous loop 316. An additional bracket 320 is located between loop 316 and secondary connection loop 326. The block 402 may be connected to a boat via shaft 328 so that, when loaded, axis 312 of block 402 may be maintained at an angle to boat connection axis 329.

Bracket 320 has U-shaped side legs 319 and integral base 321. The loop 316 passes within U shaped legs 319 (shown at 339 of FIG. 10b) and under base 321. The loop 316 is held in the centreline 314 of block 402 by whipping 318 and screw and washer 324 centrally in base 321.

The base 321 has a circular outer portion so that the secondary loop 326 passing through the base 321 is located centrally in bracket 320 at 313 and can rotate about a generally vertical axis.

FIG. 10b is a cross section of block 402 at 322 showing a plan view of the primary loop 316 passing under bracket 321. Secondary loop 326 passes over circular base 321 and around shaft 328. Secondary loop 326 is held centrally with respect to block 402 centreline 314 in bracket 320 but is able to rotate through angle 340 with respect to block axis 312.

Thus continuous integrity and safety of connection loops 316 and 326 can be maintained between block 402 and boat shaft 328 while allowing angular rotation 340 between block 402 and boat connection shaft 328.

It should be noted that it with respect to FIG. 10b it is possible to provide guides or stops shown dotted at 380a and 380b to maintain a specific angle between axis 312 of block 402 and axis 329 of shaft 328.

It should be noted that the concepts disclosed are not meant to be complete or define a particular model or limit the concepts or application in any way. Various arrangements are shown but any one arrangement may be applied to another without limit.

From the foregoing it should be readily evident that that there has been provided an improved lightweight high load block assembly and connection method.

1. A block including:
at least one sheave mounted for rotation about a hollow axle;
at least one length of flexible material extending through the hollow axle and around the sheave,
whereby a tensile load may be transferred from the at least one length to the sheave via the hollow axle, and
wherein at least one length forms at least one discontinuous loop having two ends and wherein at least one of the ends includes a head assembly, said head assembly including an eye and a pin located within the eye.

2. The block of claim 1 wherein at least two ends engages an opposite end of the axle.

3. The block of claim 1 wherein, when the pin is not located in the eye, the eye may pass through the axle.

4. The block of claim 1 wherein at least one head assembly includes a head, said head having a bore through which the first eye may pass through when the pin is not located in the eye.

5. The block of claim 4 wherein the bore includes a countersunk portion at one end thereof for receiving the first eye with the end of the loop extending through the bore.

6. The block of claim 4 wherein the head comprises a cone with a planar base, said bore extending generally along the axis of the cone from the planar base to the apex of the cone.

7. The block of claim 6 wherein the countersunk portion is at the end of the bore remote from the planar base.

8. The block of claim 4 wherein the head is toroidal.

9. The block of claim 1 wherein at least two ends include a head assembly.

10. The block of claim 1 wherein another of said ends includes a second eye, said second eye and a head assembly adapted to engage each other.

11. The block of claim 10 wherein the second eye and the head assembly are located at opposite ends of the same length of material.

12. The block of claim 10 wherein the second eye and the head assembly are located on different lengths of material.

13. A block including:
at least one sheave mounted for rotation about a hollow axle;
at least one length of flexible material extending through the hollow axle and around the sheave,
whereby a tensile load may be transferred from the at least one length to the sheave via the hollow axle, and
wherein the at least one length forms at least one continuous loop that extends through the axle.

14. The block of claim 13 including at least one side plate extending on either side of the sheave and spacing the at least one length from the sheave.

15. The block of claim 14 wherein the at least one length is secured to at least one side plate.

16. The block of claim 14 wherein at least one strap extends around the side plates and the at least one length.

17. The block of claim 14 including a spacer assembly extending between said side plates.

18. The block of claim 17 wherein the at least one strap is secured to the spacer assembly.

19. The block of claim 13 including a swivel assembly supported by said at least one loop.

20. The block of claim 19 wherein the swivel assembly includes:
a support member supported by said at least one loop, and
a keeper, rotatably mounted on the support member, said keeper for attachment to a tensile load.

21. The block of claim 20 wherein the keeper rotates about an axis substantially perpendicular to the axis of rotation of the sheave.

22. The block of claim 20 wherein the support member is supported by at least two sets of lengths loop material, said sets being spaced apart and generally parallel to each other.

23. The block of claim 22 wherein each of the at least two sets extends through a respective bore in the support member, said bores being spaced apart and generally parallel.

24. The block of claim 21 wherein the at least two sets extend under the support member.

25. The block of claim 22 wherein the at least two sets extend generally parallel to the axle.

26. The block of claim 22 wherein the at least two sets extend generally perpendicular to the axle.

27. The block of claim 20 wherein the keeper has a bore adapted to receive a loop.

28. (canceled)
